(19) United States
(12) Patent Application Publication
(10) Pub. No.: US 2007/0114480 A1
(43) Pub. Date: May 24, 2007

(54) Vorticity generators for use with fluid control systems

(76) Inventor: Joseph Michael Burke, Lee, NH (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/286,921

(22) Filed: Nov. 23, 2005

(51) Int. Cl. F16K 47/00

(52) U.S. Cl. 251/126

(57) ABSTRACT

An example valve includes a valve body and a fluid passage therethrough. The fluid passage includes an inlet, an outlet and a stagnation area. The valve includes a control element within the fluid passage to control the flow of fluid through the passage and a vortex generating structure to direct a fluid within the fluid passage into the stagnation area.

### FIELD OF THE DISCLOSURE

This disclosure relates generally to fluid control systems and, more particularly, to methods and apparatus to generate fluid vortices in stagnation areas in fluid control systems.

### BACKGROUND

Typically, it is necessary to control process fluids in industrial processes, such as oil and gas pipeline distribution systems, chemical processing plants, and sanitary processes such as, for example, food and beverage processes, pharmaceutical processes, cosmetics production processes, etc. Generally, process conditions, such as pressure, temperature, and process fluid characteristics dictate the type of valves and valve components that may be used to implement a fluid control system. Valves typically have a fluid passageway, including an inlet and an outlet, which passes through the valve body. Other valve components, such as a bonnet, a valve stem or a flow control element may extend into the passageway. Often, the configuration of these components in the passageway results in fluid stagnation areas, which are particularly problematic in fluid control systems that require sanitary conditions. In the stagnation areas, the flow of fluid is reduced, air pockets may form and, as a result, microorganisms and other contaminants may accumulate within the valve and/or other areas along the path of fluid flow.

FIG. 1 is a cross-sectional view of an example of a known sliding stem plug valve 100. The example valve 100 includes a valve body 102 that connects to a fluid pipeline (not shown) and receives an inlet fluid at an inlet passageway 104 which couples to an outlet passageway 106 through a valve seat 108. A bonnet 110, which is mounted to the valve body 102, guides a valve stem 114, an end of which is coupled to a flow control element or plug 112. The plug 112 is configured to releasably engage the seat 108 to control or modulate the flow of the fluid through the passageway 104, 106.

When the plug 112 is in the position shown in FIG. 1, the valve 100 is open and fluid travels in the direction of the arrows past the seat 108. Fluid also flows into stagnation areas 116 and may not be adequately washed out during successive openings and closings of the plug 112. Thus, the stagnation areas 116, which are commonly referred to as dead space or dead legs, may accumulate fluid, air, microorganisms, and/or other contaminants and, consequently, contaminate the process fluid.

In the food processing, cosmetic and bio-technical industries, it is common to employ valves, pipes and other fluid control components that promote sanitary conditions by, for example, preventing the accumulation of contaminants within the fluid control components. One such example is shown in FIG. 2 in which a single-seat angle valve 200 has a valve body 202 for connection to a fluid pipeline and receives an inlet fluid at an inlet passageway 204 under pressure for coupling to an outlet passageway 206 through a valve seat 208. A bonnet 210 is mounted to the valve body 202 and guides a valve stem 214 that is coupled to a plug 212. As the valve stem 214 slides within the bonnet 210, the plug 212 releasably engages the seat 208. Stem seal 216 and bonnet seal 218 seal the bonnet 210 to the stem 214 and valve body 202, respectively.

In the design of FIG. 2, the bonnet seal 218 and the stem seal 216 are relatively close to the seat 208 and substantially flush with the side of the valve body 202 at the inlet passageway 204. In this manner, the valve 200 provides a fluid flow path with reduced or minimal stagnation areas, thereby enabling the valve 200 to be used in fluid control applications that require sanitary conditions. However, the design shown in FIG. 2 is relatively complex and expensive.

### SUMMARY

In accordance with one example, a valve includes a valve body and a fluid passage therethrough. The fluid passage includes an inlet, an outlet and a stagnation area. The valve includes a control element within the fluid passage to control a flow of fluid through the passage and a vortex generating structure to direct a fluid within the fluid passage into the stagnation area.

In accordance with another example, a vortex generating apparatus includes a fluid communication element, a fluid stagnation area proximate to the fluid communication element, and a vortex generator coupled to the fluid communication element. The vortex generator is adapted to generate at least one vortex in the fluid stagnation area.

In accordance with yet another example, a fluid communication device includes a passage for communicating fluid through the fluid communication device, a stagnation area within the passage, and a diverting structure within the passage. The diverting structure is configured to divert fluid into the stagnation area.

### BRIEF DESCRIPTION OF THE DRAWINGS

FIG. 1 is a cross-sectional view of a known sliding stem valve.

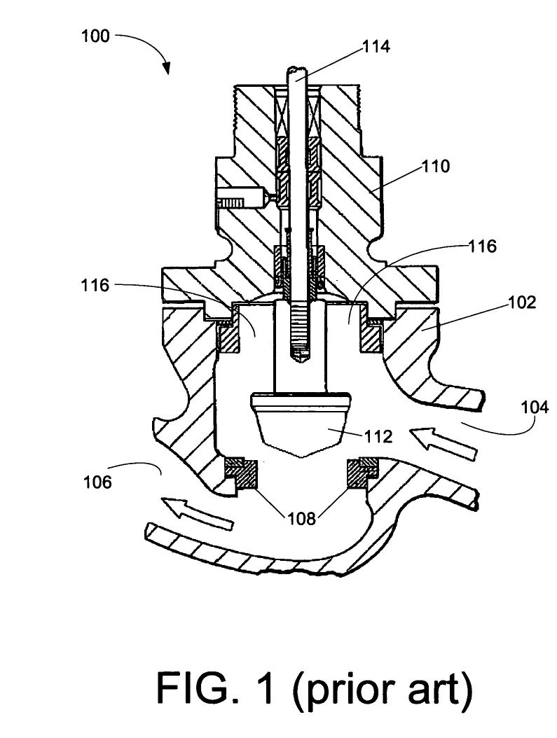

FIG. 2 is a cross-sectional view of a known angle body sliding stem valve design that may be used in sanitary fluid control systems.

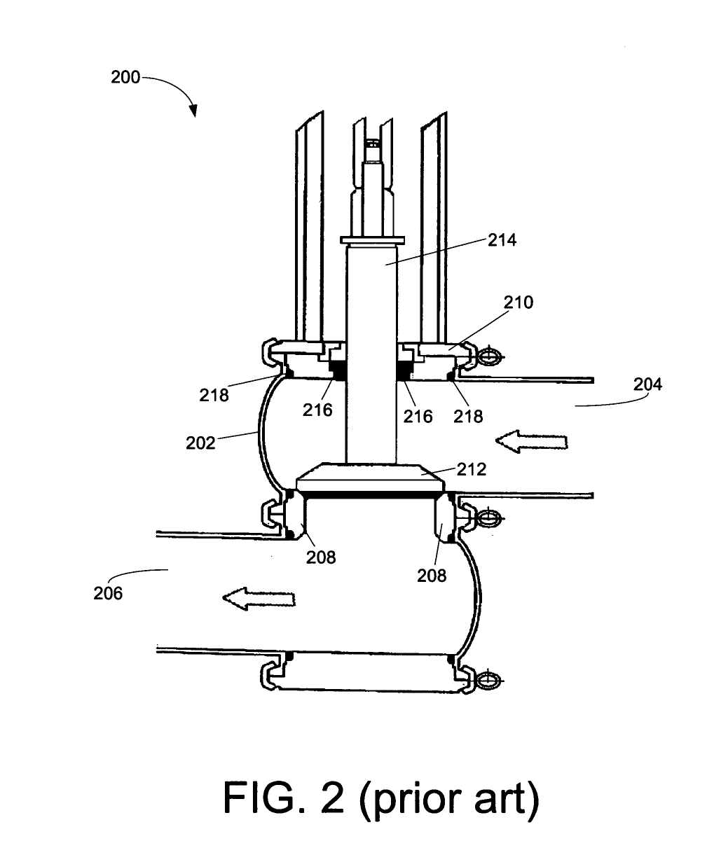

FIG. 3 is a cross-sectional view of an example angle body sliding stem valve including an example vortex generator.

FIG. 4 is a cross-sectional view of an alternative example angle body sliding stem valve with an alternative example vortex generator.

FIG. 5 is a partial cross-sectional view of another alternative example angle body sliding stem valve with another alternative example vortex generator.

### DETAILED DESCRIPTION

In general, the example fluid control valves described herein include a valve body through which fluid may flow via a fluid passage having an inlet and an outlet. The fluid passage may have one or more stagnation areas in which fluids and/or contaminants may accumulate. To minimize and/or prevent the adverse effects of the stagnation area(s) (e.g., bacteria growth), the example fluid control valves described herein include a vortex generating structure configured to direct fluid into the stagnation area(s).

Some known fluid control valves incorporate fluid passage designs that are substantially void of stagnation areas. However, such fluid passage designs typically increase the complexity and manufacturing cost of a fluid valve. In contrast, the example fluid control valves described herein include a vortex generating structure that enables the use of relatively easy-to-manufacture (i.e., lower cost) valve designs while eliminating or minimizing the adverse effects of stagnation areas.

In one example, a fluid control valve includes a vortex generating structure integral with a valve bonnet and/or includes a vortex generating structure upstream and proximate to any stagnation area(s) within the valve. In another example, a fluid control valve employs a vortex generating structure in a section of pipe proximate to an inlet of the valve to impart adequate fluid turbulence to incoming fluid to facilitate the flushing of any stagnation area(s) within the valve.

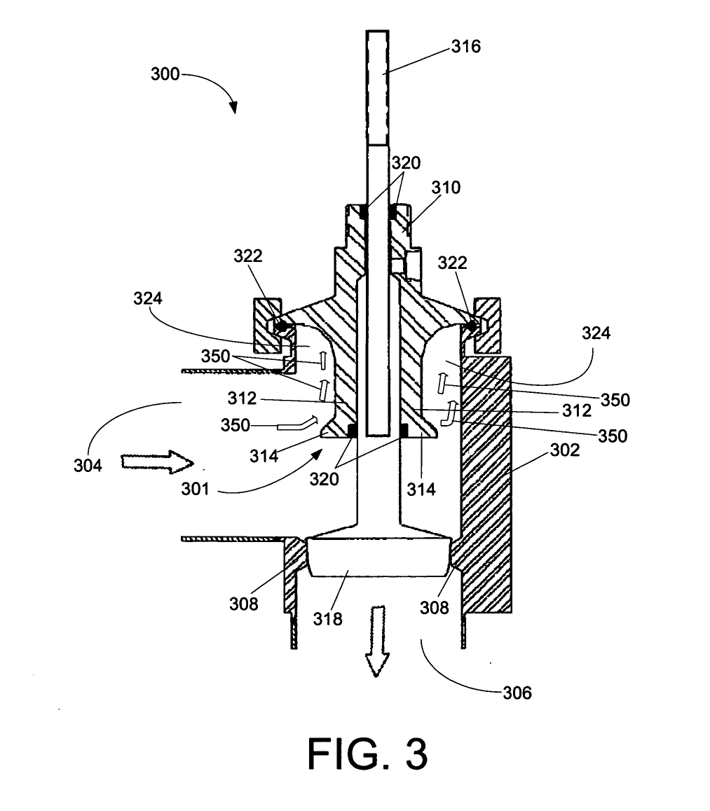

FIG. 3 is a cross-sectional view of a known angle body sliding stem valve 300 including an example vortex generator 301. As shown in FIG. 3, the example valve 300 includes a valve body 302 for connection to a fluid pipeline, or similar fluid communication element, and receiving an inlet fluid at an inlet passageway 304 under pressure for coupling to an outlet passageway 306 through a valve seat 308. A bonnet 310 is mounted to the valve body 302 and includes an extension 312 that extends into the passageway 304 and terminates in a flange-shaped structure 314 that circumfuses the bottom of the extension 312. In the example of FIG. 3, the flange-shaped structure 314 has a ramp-shaped cross-section. However, the flange-shaped structure 314 could alternatively have a curved cross-section.

A valve stem 316 extends through a center portion of the bonnet 310 and has one end that is configured to be operatively coupled to an actuator (not shown) and another end coupled to a plug 318 or other fluid control element adapted to allow and/or block fluid flow through the valve 300. The stem 316 is axially slidable within the bonnet 310 and sealed to the bonnet 310 via a stem seal 320. The bonnet 310 is further sealed to the valve body 302 via a bonnet seal 322. The seals 320 and 322 may be O-rings or other suitable sealing structures that surround the stem 316 and the bonnet 310, respectively, to prevent process fluid from leaking or seeping out of the valve 300.

The plug 318 is adapted to axially engage the valve seat 308 and control the flow of fluid through the valve 300 via the passageways 304 and 306. In the position shown in FIG. 3, the plug 318 is in contact with the valve seat 308 and the valve 300 is closed, i.e., process fluid will not flow through the valve 300 from the inlet passageway 304 to the outlet passageway 306. When the valve stem 316 is raised, the plug 318 is lifted from the seat 308 to enable fluid to flow past the valve seat 308 and toward the outlet passageway 306, i.e., the valve 300 is open.

In the open position or the closed position, process fluid including liquids and gases, may accumulate in a dead leg or stagnation area 324, which is an area of fluid stagnation around the bonnet 310 near an upper portion of the extension 312. However, the flange 314 alters the flow of the fluid in the passageways 304 and 306 as shown by example fluid flow arrows 350. In particular, fluid flowing through the inlet passageway 304 strikes the flange 314, which diverts or directs some of the fluid into the stagnation area 324 to create vortices or eddies therein. In other words, the flange 314 functions as a downstream flow impediment that creates a hydraulic jump, which dissipates energy as turbulence or vorticies. The turbulence or vortices clear out the stagnation area 324 by making them less stagnate, which breaks up or removes air pockets and cleans out microorganisms, fluids, and/or any other contaminants that have accumulated therein.

Generally, it is undesirable to create vortices, eddies, or other turbulence in process fluid systems because such turbulence is considered inefficient (i.e., vortices, eddies, turbulence, etc. tend to increase flow resistance). As is known, a straight-sided bonnet is relatively efficient and provides a relatively low flow coefficient or flow resistance. However, such straight-sided bonnets do not promote sanitary conditions for valves having a dead leg or stagnation area.

As described above in connection with the example valve 300, the flange 314 functions as a vorticity generator, which creates vorticies, eddies, or turbulence in the stagnation area 324 and drives out gasses (e.g., air) or other stagnant fluids and creates a fluid velocity that prevents the accumulation and attachment of organisms, such as, for example, bacteria or other contaminants. Thus, the flange 314 causes at least some of the fluid passing through the valve 300 via the passageways 304 and 306 to be diverted or directed in a manner that cleans the stagnation area 324.

The vortex generator 301 may be used to facilitate and/or improve clean-in-place (CIP), hot-water-in-place (HWIP), steam-in-place (SIP) and/or other well-known cleaning processes. For example, the vortex generator 301 may be used to direct cleaning chemicals, hot water, and/or steam into the stagnation area 324 as described above. When used with CIP systems, the vortex generator 301 increases efficiency of the cleaning process by requiring less rinse water after cleaning agents clean an inside surface of the valve 300. Alternatively or additionally, the cleaning process can be performed using only hot water or a caustic material followed by hot water instead of a caustic material followed by steam. In any case, the vortex generator 301 of FIG. 3 simplifies cleaning processes by requiring fewer steps and/or less cleaning material and, as a result, can significantly reduce the costs associated with cleaning a fluid control system.

In the example valve of FIG. 3, the flange 314 has an angled or ramp-shaped cross-section. However other shapes or configurations could be utilized to generate vortices in the stagnation area 324. For example, the flange 314 could be implemented as a curved structure integrally formed with the extension 312 and/or the bonnet 310. Alternatively or additionally, the flange 314 or other vortex generating structure may be a separate component that is coupled to the extension 312 and/or the bonnet 310.

Furthermore, the vortex generator 301 may be used on other components in a fluid control system. For example, the example vortex generator 301 may be used in connection with T-mounted sensors in the process stream such as, for example, a temperature probe. A temperature probe mounted on the top of a pipeline may create dead legs in the adjacent area of the process stream. Coupling the sensor with a vortex generator such as the example vortex generator 301 would reduce the stagnation in the dead legs and promote sanitary conditions in a manner similar to that described above.

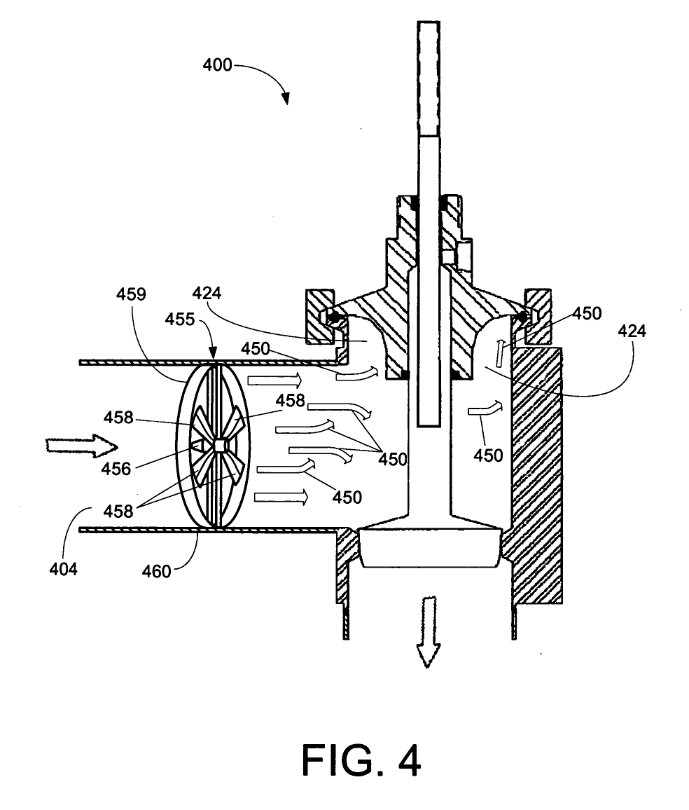

In an alternative embodiment shown in FIG. 4, a sliding stem valve 400 has neither an extension nor a flange as described in connection with the example valve of FIG. 3. In the embodiment of FIG. 4, the vortex generating structure includes a static propeller 455 coupled to a pipe 460 adjacent to an inlet passageway 404. The propeller 455 has a central hub 456 to which blades 458 are coupled. The hub 456 is supported by a hoop structure 459 that allows coupling of the static propeller 455 to the pipe 460. In alternative embodiments, the propeller 455 may also be coupled as a separate or modular device that is mounted between pipe flanges or sanitary fittings.

In the example of FIG. 4, the propeller 455 is fixed so that it does not spin or otherwise rotate relative to the pipe 460. As streamlines or stream tubes of water pass through the propeller 455, the shape of the blades 458 causes the fluid to form vortices as shown by the arrows 450. The propeller 455 may be particularly useful in long pipelines in which a full laminar boundary layer has formed at the pipe wall. The vortices induced by the propeller 455 reduce the boundary layer that builds up near the walls of the pipe 460 and clean out a stagnation area 424 and/or other contaminants. Although the propeller 455 of the present example has four blades 458, the propeller 455 may have any other number of blades.

Instead of, or in addition to the propeller 455, individual blades may be attached to the pipe 460 interior without the hub 456. Such individual blades, attached to the pipe 460 and separated by a longitudinal distance, impart a vortex in the fluid while minimizing fluid flow resistance. The number and placement of the individual blades permit a tradeoff between fluid flow resistance while causing fluid to spin with respect to the axis of the pipe 460, thereby directing fluid into the stagnation area 424. As with the flange 314 of the example shown in FIG. 3, the propeller 455 or individual blades of the present example facilitate or improve cleaning of the stagnation area 424 by preventing the accumulation of contaminants under normal operation with process fluids. Furthermore, the present example diverts cleaning fluids and/or hot water into the stagnation area 424, thereby improving efficiency of the CIP, HWIP, SIP, and/or other cleaning processes.

In addition, the example propeller 455 may also be used in other areas of a fluid control system. For example, in a fluid control system such as, for example, a sanitary system, laminar boundary layers may form in a long straight run of a pipe. In that boundary layer the shear due to velocity is low enough that contaminants such as, for example, bacteria growth, may accumulate. Positioning a propeller 455, or other vortex generating structure, in the straight run would generate swirling turbulence throughout the stream, even along the pipe walls, which helps disintegrate the boundary layer and, thus, clear out the contaminants. Not only would this configuration enable effective cleaning at low velocities, the vortex generating structure may clean the pipes better than current line velocities.

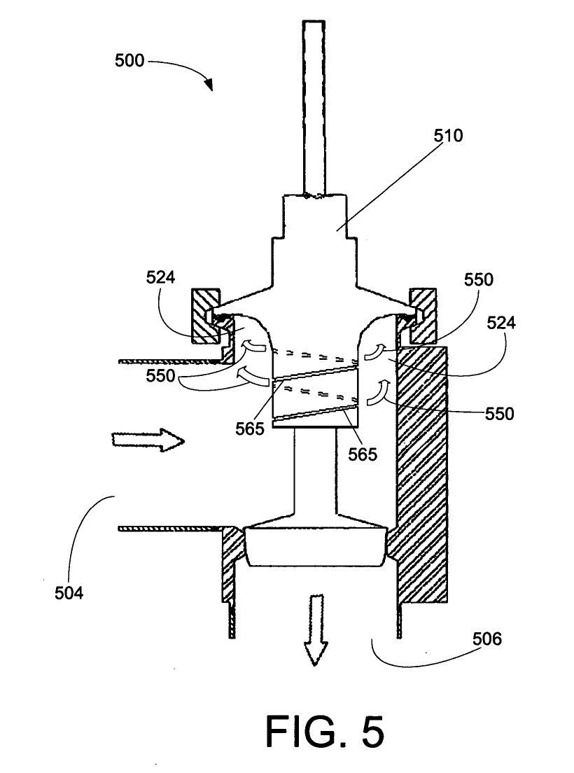

In an alternative embodiment shown in FIG. 5, a sliding stem valve 500 has a bonnet 510 including a vortex generating spiral structure, such as spiral grooves 565. The grooves 565 may be integrally formed on a portion of the bonnet 510 that extends into the passageways 504 and 506 and extends around the lower portion of the bonnet 510 to divert fluid flow into a stagnation area 524. At least some of the fluid flowing through the valve 500 impinges on the bonnet 510 and engages the spiral grooves 565 to cause the fluid to rotate about the bonnet 510, which causes at least some of the fluid to be directed into the stagnation area 524 as shown by arrows 550. Additionally, the spiral grooves 565 may extend along the full length of the bonnet 510 or only portion thereof. Also, the geometry of the spiral grooves 565 may contain full and/or partial twists. As described above with the other example vorticity generators and fluid diverting structures, the spiral grooves 565 may be used to facilitate CIP, HWIP, SIP and/or any other cleaning process.

In yet another alternative embodiment, the spiral structure includes a spiral ridge instead of the spiral grooves 565 of FIG. 5. Such a spiral ridge, formed around an outer portion of a bonnet, may further include a sloped, curved, and/or ramp-shaped cross-section. Fluids striking the ridge are diverted into the stagnation area 524.

The example vortex generating structures could be used to reduce the need for cleaning processes to be performed in fluid communication systems due to a reduction and/or prevention of the stagnation of fluid in a dead leg or other stagnation area(s). Such a reduction and/or prevention of fluid stagnation promotes sanitary conditions and decreases the presence of contaminants in the process fluid. For example, increased turbulence in fluid stagnation areas reduces or eliminates conditions favorable to bacterial growth, thereby decreasing the frequency at which cleaning processes must be performed on a fluid distribution or control system. This decreased need for cleaning reduces cleaning costs including the costs associated with downtime of the fluid processing system.

Further, the example vortex generating structures enable cleaning processes (e.g., CIP, HWIP, SIP, etc.) to operate more efficiently by directing or diverting cleaning chemicals, steam, and/or hot water into stagnation areas. The increased efficiency of cleaning operations may decrease the amount of chemicals and/or energy needed to perform the cleaning processes.

Still further, the example vortex generating structures could be coupled to or formed within other structures or components of a valve, pipeline or other fluid or material communication element or device. For example, a temperature or other sensor in a valve or a pipe may be fitted with a ramp-shaped, curved or spiral structure, such as the example described above with respect to FIG. 3, to direct fluid into stagnation areas. In addition, the example vortex generating structures described herein may be used at T-junctions, Y-junctions and/or inlets and outlets of pipelines or tanks.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A valve comprising:
a valve body;
a fluid passage through the valve body, the fluid passage including an inlet, outlet and a stagnation area;
a control element within the fluid passage to control a flow of fluid through the passage; and
a vortex generating structure to direct a fluid within the fluid passage into the stagnation area.

2. A valve as defined in claim 1, wherein the vortex generating structure is adapted to reduce fluid stagnation in the valve.

3. A valve as defined in claim 1, wherein the vortex generating structure is adapted to reduce an accumulation of air pockets in the valve.

4. A valve as defined in claim 1, wherein the vortex generating structure is adapted to reduce accumulation of contaminants in the valve.

5. A valve as defined in claim 1, further comprising:
a valve seat within the fluid passage; and
a bonnet extending from the valve body, the bonnet including a valve stem axially slidable within the bonnet, the valve stem having a first end configured to be operatively coupled to an actuator and a second end configured to be coupled to the control element, the control element adapted to axially engage the valve seat.

6. A valve as defined in claim 5, wherein the control element comprises a plug.

7. A valve as defined in claim 5, wherein the vortex generating structure is fixed to the bonnet.

8. A valve as defined in claim 5, wherein the vortex generating structure is integrally formed with the bonnet.

9. A valve as defined in claim 5, wherein the vortex generating structure comprises at least one spiral structure on a portion of the bonnet.

10. A valve as defined in claim 1, wherein at least a portion of the vortex generating structure has a ramp-shaped cross-section.

11. A valve as defined in claim 1, wherein at least a portion of the vortex generating structure is curved.

12. A valve as defined in claim 1, wherein the vortex generating structure comprises a propeller.

13. A vortex generating apparatus comprising:
a fluid communication element;
a fluid stagnation area proximate to the fluid communication element; and
a vortex generator coupled to the fluid communication element and adapted to generate at least one vortex in the fluid stagnation area.

14. A vortex generating apparatus as defined in claim 13, wherein the fluid communication element comprises a valve.

15. A vortex generating apparatus as defined in claim 13, wherein the fluid communication element comprises a pipe.

16. A vortex generating apparatus as defined in claim 13, wherein the vortex generator comprises a protrusion on the fluid communication element.

17. A vortex generating apparatus as defined in claim 16, wherein at least a portion of the protrusion has a ramp-shaped cross-section.

18. A vortex generating apparatus as defined in claim 16, wherein the protrusion is integrally formed with the communication element.

19. A vortex generating apparatus as defined in claim 16, wherein at least a portion of the protrusion is curved.

20. A vortex generating apparatus as defined in claim 13, wherein the vortex generator comprises at least one spiral structure on a portion of the communication element.

21. A vortex generating apparatus as defined in claim 13, wherein the vortex generator comprises a propeller.

22. A fluid communication device, comprising:
a passage for communicating fluid through the fluid communication device;
a stagnation area within the passage; and
a diverting structure within the passage and configured to divert fluid into the stagnation area.

23. A fluid communication device as defined in claim 22, wherein the passage is associated with a valve.

24. A fluid communication device as defined in claim 22, wherein the passage is associated with a pipe.

25. A fluid communication device as defined in claim 22, wherein at least a portion of the diverting structure is ramp-shaped.

26. A fluid communication device as defined in claim 22, wherein at least a portion of the diverting structure is curved.

27. A fluid communication device as defined in claim 22, wherein the diverting structure comprises a propeller.

28. A fluid communication device as defined in claim 22, wherein the diverting structure comprises at least one spiral-shaped structure.
